(19) United States
(12) Patent Application Publication
(10) Pub. No.: US 2025/0391115 A1
(43) Pub. Date: Dec. 25, 2025

(54) METHOD AND APPARATUS FOR DATA SYNTHESIZING, DEVICE, STORAGE MEDIUM AND PROGRAM PRODUCT

(71) Applicant: Beijing Zitiao Network Technology Co., Ltd., Beijing (CN)

(72) Inventors: Fan Zhang, Beijing (CN); Junjie Luo, Beijing (CN)

(21) Appl. No.: 19/241,639

(22) Filed: Jun. 18, 2025

(30) Foreign Application Priority Data
Jun. 19, 2024 (CN) 202410793808.3

(51) Int. Cl. G06T 17/20; G06V 10/74

(52) U.S. Cl. CPC G06T 17/20; G06V 10/761

(57) ABSTRACT

Embodiments of the present disclosure provide a method and apparatus for data synthesizing, a device, a storage medium and a program product. The method includes: obtaining model data of candidate models from a preset three-dimensional model library, wherein the preset three-dimensional model library includes model data of three-dimensional models of a target object; fusing model data of the candidate models to obtain a fusion model; and obtaining auxiliary information and fusing the auxiliary information into the fusion model to obtain a target model, wherein the auxiliary information includes at least one option selected from a group of expression control information, illumination control information and texture control information. Embodiments of the present disclosure can solve the problem of inefficiency of model creation caused by creating the model using data of the target object in a real scenario.

### CROSS-REFERENCE TO RELATED APPLICATIONS

This application claims the priority to and benefits of the Chinese Patent Application, No. 202410793808.3, filed on Jun. 19, 2024. The aforementioned patent application is hereby incorporated by reference in its entireties.

### TECHNICAL FIELD

Embodiments of the present disclosure relate to computer techniques, and in particular to a method and apparatus for data synthesizing, a device, a storage medium and a program product.

### BACKGROUND

With the development of computer vision, virtual person portraits, as three-dimensional models of their target objects, are widely applied to scenarios such as model training, data enhancement or test.

At present, data of a target object are acquired and computer vision techniques are used to generate a virtual person portrait of the target object on the basis of the acquired data. However, the above-mentioned process of creating a virtual person portrait needs acquiring data of a target object in a real scenario and generating the virtual person portrait on the basis of the acquired data. In this process, a relatively long period of time is taken and the effect of the virtual person portrait is limited by the real scenario, making it difficult to satisfy expectations of the user.

### SUMMARY

Embodiments of the present disclosure provide a method and apparatus for data synthesizing, a device, a storage medium and a program product for efficiently obtaining virtual person portraits that satisfy expectations.

In a first aspect, embodiments of the present disclosure provide a method for data synthesizing. The method includes:
obtaining model data of candidate models from a preset three-dimensional model library, wherein the preset three-dimensional model library includes model data of three-dimensional models of a target object;
fusing model data of the candidate models to obtain a fusion model; and
obtaining auxiliary information and fusing the auxiliary information into the fusion model to obtain a target model, wherein the auxiliary information includes at least one option selected from a group of expression control information, illumination control information and texture control information.

In a second aspect, embodiments of the present disclosure provide an apparatus for data synthesizing. The apparatus includes:
a data obtaining module, configured to obtain model data of candidate models from a preset three-dimensional model library, wherein the preset three-dimensional model library includes model data of three-dimensional models of a target object;
a fusion module, configured to fuse model data of the candidate models to obtain a fusion model; and
a model generation module, configured to obtain auxiliary information and fuse the auxiliary information into the fusion model to obtain a target model, wherein the auxiliary information includes at least one option selected from a group of expression control information, illumination control information and texture control information.

In a third aspect, embodiments of the present disclosure provide an electronic device. The electronic device includes:
one or more processors; and
a storage apparatus used to store one or more programs,
wherein the one or more programs, when executed by the one or more processors, cause the one or more processors to implement the method for data synthesizing according to embodiments of the present disclosure.

In a fourth aspect, embodiments of the present disclosure provide a storage medium containing computer-executable instruction. The computer-executable instruction, when executed by a computer processor, is used to perform the method for data synthesizing according to embodiments of the present disclosure.

In a fifth aspect, embodiments of the present disclosure provide a computer program product. The computer program product includes a computer program that, when executed by a processor, implements the method for data synthesizing according to embodiments of the present disclosure.

An embodiment of the present disclosure provides a method for data synthesizing, in which a fusion model is obtained by fusing model data of candidate models and then at least one option selected from a group of expression control information, illumination control information and texture control information is fused into the fusion model to obtain a target model. Since the fusion model is a three-dimensional model of a target object, generating the three-dimensional model by fusing model data of candidate models can solve the problem of inefficiency of model creation caused by creating the model using data of the target object in a real scenario. Since expression effects of the fusion model can be controlled through expression control information and the lighting effects of the fusion model can be controlled through illumination control information, a target model satisfying expectations about facial expression and lighting effects can be generated.

### BRIEF DESCRIPTION OF DRAWINGS

Combining the accompanying drawings and referring to the specific implementations described below, the above and other features, advantages, and aspects of embodiments disclosed herein will become more apparent. Throughout the drawings, the same or similar reference numerals indicate the same or similar elements. It should be understood that the attached drawings are illustrative, and the originals and the elements may not be drawn to scale.

FIG. 1 is a schematic flowchart of a method for data synthesizing according to an embodiment of the present disclosure;

FIG. 2 is a schematic diagram illustrating model fusion according to an embodiment of the present disclosure;

FIG. 3 is another schematic flowchart of a method for data synthesizing according to an embodiment of the present disclosure;

FIG. 4 is yet another schematic flowchart of a method for data synthesizing according to an embodiment of the present disclosure;

FIG. 5 is a structural diagram of an apparatus for data synthesizing according to an embodiment of the present disclosure; and

FIG. 6 is a structural diagram of an electronic device according to an embodiment of the present disclosure.

### DETAILED DESCRIPTION

The embodiments of the present disclosure will be described in more detail below with reference to the accompanying drawings. Although certain embodiments of the present disclosure are shown in the accompanying drawings, it should be understood that the present disclosure may be implemented in various forms and should not be construed as limited to the embodiments set forth herein. Instead, these embodiments are provided for a more thorough and complete understanding of the present disclosure. It should be understood that the drawings and embodiments disclosed herein are for illustrative purposes only and are not intended to limit the scope of protection of the present disclosure.

It should be understood that the various steps described in the disclosed method embodiments may be executed in different orders and/or in parallel. In addition, the method implementation may include additional steps and/or omit the steps shown. The scope of the present disclosure is not limited in this regard.

The term “including” and its variations used herein are open-ended, meaning “including but not limited to”. The term “based on” means “based at least in part”. The term “an embodiment” means “at least one embodiment”. The term “another embodiment” means “at least one further embodiment”. The term “some embodiments” means “at least some embodiments”. The relevant definitions of other terms will be provided in the following description.

It should be noted that the concepts such as “first” and “second” mentioned herein are only used to distinguish different devices, modules, or units, and are not intended to limit the order or interdependence of the functions performed by these devices, modules, or units.

It should be noted that the modifications of “one” and “multiple” mentioned herein are illustrative rather than restrictive, and those skilled in the art should understand that unless otherwise explicitly stated in the context, they should be understood as “one or more”.

The names of messages or information communicated between a plurality of apparatuses in implementations of the present disclosure are used only for the purpose of illustration rather than limiting the scope of the messages or information.

It can be understood that the user should be informed the type, usage scope, usage scenario and the like of his personal information involved in the present disclosure and user authorization should be acquired in a proper manner according to relevant laws and regulations before using the technical solutions disclosed by embodiments of the present disclosure.

For example, in response to receiving an active request from a user, prompt information is sent to the user to notify the user expressly that personal information of the user needs to be acquired and used for his requested operation. As such, the user may be enabled to make his own choice about whether to provide personal information to the software or hardware, such as electronic device, application program, server or storage medium, that performs the operations of the technical solutions in the present disclosure.

As an optional, not limiting, implementation, in response to receiving an active request from a user, the manner, in which the prompt information is sent to the user, may be, for example, a pop-up window, within which the prompt information can be presented in text. Additionally, the pop-up window may also carry selection controls for the user to choose “agreement” or “disagreement” of providing personal information to an electronic device.

It can be understood that the above-described process of user informing and user authorization acquisition is only illustrative, and not intended to limit implementations of the present disclosure. Other manners satisfying relevant laws and regulations may also be applied to implementations of the present disclosure.

It can be understood that data involved in the present technical solutions (including the data themselves as well as acquisition and usage of the data) should follow requirements of corresponding laws and regulations.

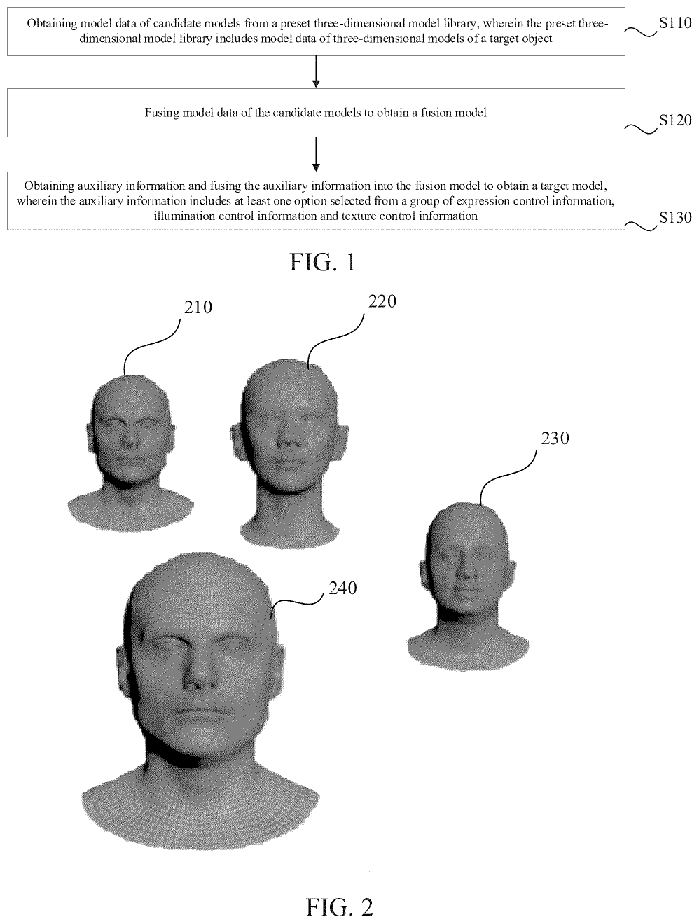

FIG. 1 is a schematic flowchart of a method for data synthesizing in an embodiment of the present disclosure. The embodiments of the present disclosure are applicable to a scenario of creating a virtual person portrait, for example, a scenario of obtaining a virtual person portrait by fusing a plurality of three-dimensional models of a target object in real scenarios. The method may be performed by a digital synthesizing apparatus that can be implemented in software and/or hardware and optionally by an electronic device. The electronic device may be a mobile terminal, a Personal Computer (PC) terminal, a server or the like.

As shown in FIG. 1, the method includes the following steps.

In S110, model data of candidate models are obtained from a preset three-dimensional model library. The preset three-dimensional model library contains model data of three-dimensional models of a target object.

Here, the target object includes a human face, an animal face and the like.

In embodiments of the present disclosure, candidate models represent three-dimensional models used to compose a virtual person portrait. At least two three-dimensional models may be selected from the preset three-dimensional model library as candidate models on the basis of random selection. Three-dimensional models in the preset three-dimensional model library may also be presented for the user to select at least two three-dimensional models as candidate models.

The model data include 3D point data information. Here, the 3D point data information includes vertex coordinates of a mesh constituting a three-dimensional model, a gaze direction vector, expression description and the location and intrinsic parameters of a camera. Expression description represents a plurality of BlendShape fusions.

The manner for creating the preset three-dimensional model library includes scanning a person in a real scenario using a 3D scanner or a depth camera to collect data of the person. Three-dimensional reconstruction is performed according to the data of the person to obtain a three-dimensional model such as a point cloud model or a mesh model of the person in the real scenario. Model data of the three-dimensional model generated on the basis of the person in the real scenario are stored in the preset three-dimensional model library. For example, the preset three-dimensional model library may be denoted by (A1, A2, A3 . . . Ai . . . An), wherein Ai (i∈[1, n]) denotes model data of an ith three-dimensional model in the preset three-dimensional model library.

Since three-dimensional models of different target objects need to be fused to obtain a new three-dimensional model, at least two candidate models need to be selected from the preset three-dimensional model library, so that model data of at least two candidate models in the preset three-dimensional model library are acquired. For example, two three-dimensional models can be obtained from the preset three-dimensional model library as a father model and a mother model respectively. To add a mutation feature, at least one candidate model may also be obtained from the preset three-dimensional model library as a mutation model.

Illustratively, three-dimensional models in the preset three-dimensional model library are displayed; a configuration operation on the three-dimensional models is obtained, and candidate models and role properties are determined on the basis of the configuration operation, wherein the role property specifies a candidate model as a father model, a mother model or a mutation model; and model data corresponding to the father model, the mother model and the mutation model respectively are obtained from the preset three-dimensional model library.

Since three-dimensional models in the preset three-dimensional model library are three-dimensional models of persons in real scenarios, the three-dimensional models in the preset three-dimensional model library may be rendered to display the individual three-dimensional models. In response to the configuration operation on the three-dimensional models, a plurality of candidate models are determined from the preset three-dimensional model library and each specified as a father model, a mother model or a mutation model. Then, model data corresponding to the father model, the mother model and the mutation model are obtained from the preset three-dimensional model library respectively. Since at least one three-dimensional model is selected from the preset three-dimensional model library as a mutation model, more mutation features are introduced into the model fusion process, so that the fusion model obtained from the fusion may have mutation features while inheriting features from the father model and the mother model and comply better with the inheritance law for persons in real scenarios.

Optionally, model data of a plurality of candidate models may be randomly obtained from the preset three-dimensional model library, and role properties may be randomly specified for the individual candidate models. For example, model data of the three models A2, A3 and A5 are randomly obtained from the preset three-dimensional model library, and in a random manner, the candidate model A2 is specified as a father model, the candidate model A3 is specified as a mother model and the candidate model A5 is specified as a mutation model. The manner, in which model data of candidate models are obtained, is not limited specifically in embodiments of the present disclosure.

In S120, model data of the candidate models are fused to obtain a fusion model.

Illustratively, fusion weights for the candidate models are obtained according to the role properties of the candidate models; the model data corresponding to the father model and the model data corresponding to the mother model are fused to obtain a child model on the basis of the fusion weight corresponding the father model and the fusion weight corresponding the mother model; and the model data corresponding to the mutation model is fused into the child model on the basis of the fusion weight of the mutation model to obtain the fusion model.

Here, a fusion weight represents the degree of influence on the fusion model by the model data of a candidate model in the fusion process. The higher the fusion weight of the model data is, the more similar the fusion model is to the candidate model in the regions corresponding to the model data. In some embodiments, if the fusion model is required to be more similar to the father model, the fusion weight of the father model is selected to be higher than the fusion weight of the mother model. If the fusion model is required to be more similar to the mother model, the fusion weight of the mother model is selected to be higher than the fusion weight of the father model. Each of the fusion weights of the father model and the mother model is higher than the fusion weight of the mutation model.

The child model represents a three-dimensional model generated by fusing the model data of the father model and the model data of the mother model. Fusion weights of the father model, the mother model and the mutation model may be selected randomly from a set of fusion weights according to practical fusion requirements. FIG. 2 is a schematic diagram illustrating model fusion in an embodiment of the present disclosure. As shown in FIG. 2, on the basis of the fusion weight corresponding to a father model 210 and the fusion weight corresponding to a mother model 220, the model data corresponding to the father model 210 and the model data corresponding to the mother model 220 are processed through hybridization, backcross and self-crossing to obtain a child model (not shown in FIG. 2). During the process of composing the child model, hybridization represents weighted fusion of the model data corresponding to the father model 210 and the model data corresponding to the mother model 220. Backcross represents the weighted fusion of the model data corresponding to a filial generation and the model data corresponding to the father model 210, wherein the filial generation represents a filial generation obtained from hybridization or a filial generation obtained from backcross. Self-crossing represents weighted fusion of model data of filial generations with the same genetic characteristics, wherein the filial generation represents a filial generation obtained from backcross or a filial generation obtained from self-crossing.

On the basis of the fusion weight corresponding to a mutation model 230, the model data corresponding to the mutation model 230 and the model data corresponding to the child model are processed through hybridization, backcross and self-crossing to obtain a fusion model 240. During the process of composing the fusion model 240, the hybridization, backcross and self-crossing processing is similar to the process of composing the child model, and the difference therebetween is that composing the fusion model 240 needs hybridization, backcross and self-crossing of the model data corresponding to the mutation model 230 and the model data corresponding to the child model. No related description will be repeated here.

In S130, auxiliary information is obtained and the auxiliary information is fused into the fusion model to obtain a target model, wherein the auxiliary information includes at least one option selected from a group of expression control information, illumination control information and texture control information.

Here, the auxiliary information represents the information for effect adjustment of the fusion model. By fusing the auxiliary information into the fusion model, a target model more satisfying effect expectations can be obtained.

The expression control information represents the displacement of a vertex in a mesh that is related to a target expression when the fusion model transforms from the current expression to the target expression. The illumination control information represents the information of the illumination environment in which the target model is located. The illumination environment is used to simulate the light and shadow effects in a real illumination scenario. The texture control information represents the appearance of the target model. The texture control information may include images corresponding to skin information, hair information, eye information, accessory information, clothing information and the like. Here, the hair information includes eyebrows, beard, eyelashes, hair on the head and the like. Eyebrows of different types may be generated on the basis of brow ridge features of standard human face models. Beards of different types may also be generated on the basis of mouth features of standard human face models. Eyelashes of different makeup styles may also be generated on the basis of eye features of standard human face models. Hair of different styles and colors may also be generated on the basis of head features of standard human face models. Optionally, the standard human face models may be generated on the basis of features of different people.

Illustratively, obtaining the auxiliary information includes: obtaining a vertex displacement in a target mesh associated with a target expression in the fusion model; and acquiring an illumination environment map and a texture map from a preset material library.

Optionally, obtaining the auxiliary information may also include obtaining the displacement of a vertex in the target mesh of the fusion model associated with the target expression.

Optionally, obtaining the auxiliary information may also include obtaining an illumination environment map from the preset material library.

Optionally, obtaining the auxiliary information may also include obtaining a texture map from the preset material library.

Here, the target mesh associated with the target expression in the fusion model represents a mesh that will have change in position during the process of the fusion model transforming from the current expression to the target expression. The illumination environment map is an image containing illumination information. The texture map is an image containing texture information.

Specifically, expression controllers of the fusion model are displayed, and the expression controllers are bound with key points of parts such as eyebrows, eyes, a nose and a mouth. The parts such as eyebrows, eyes, a nose and a mouth may be controlled by the expression controllers to present a particular state, enabling the fusion model to present a corresponding expression. Optionally, expression setting operations may be input to at least one expression controller to enable the fusion model to present a corresponding expression. Duration of the expression setting operations may be taken as a time interval for adjustment. For example, if the target expression is an expression with closed eyes and puckered lips, the expression controllers corresponding to eyes and mouth need to be set. A target expression is determined according to the expression setting operations and the displacement of a vertex in the target mesh that has change in position during the process of the fusion model transforming from the current expression to the target expression is calculated. Specifically, during the process of expression adjustment through expression controllers, the time interval for adjustment is divided into N small intervals, and the deviation between the positions of a vertex of the target mesh in the fusion model associated with the target expression at the start point and the end point of a small interval is determined in real time. Relevant coefficients of the vertex in the target mesh are obtained, and relevant coefficients of an adjacent vertex are determined according to the distance from the vertex of the target mesh in the fusion model. According to relevant coefficients of vertexes in the target mesh, the joint displacement superimposed on an adjacent vertex by the displacement of one vertex in the target mesh is determined. Displacements of vertexes are determined according to positional deviations and joint displacements corresponding to individual vertexes in the target mesh. For example, vertexes of the target mesh include a, b, c, d, e, f, and g with b, c and d being vertexes adjacent to a. When the position of a is adjusted, b, c and d are displaced jointly, and as a result, the vertex position of b needs to be determined using the combination of the positional deviation and the joint displacement corresponding to b.

Since the preset material library contains illumination environment maps in different illumination environments, the illumination environment maps can be displayed for selection by the user. Additionally, the preset material library also includes texture maps of different types and they can be displayed for selection by the user. For example, the texture maps include skin maps, hair maps, accessory maps, clothing maps and the like.

Optionally, a skin map, a hair map, an accessory map, a clothing map or an illumination environment map may also be selected randomly from the preset material library.

Illustratively, fusing the auxiliary information into the fusion model to obtain a target model includes: adjusting coordinates of vertexes of the target mesh associated with the target expression in the fusion model according to the vertex displacements; and fusing the illumination environment map and the texture map into the fusion model with adjusted vertexes to obtain the target model.

For example, after vertex displacements of the target mesh corresponding to a small interval are obtained and according to the vertex displacements of the target mesh corresponding to the small interval in the time interval for adjustment, the corresponding vertex coordinates of the target mesh are adjusted to gradually adjust the expression of the fusion model, so that problems affecting expression control effects such as jagged arrangement of vertexes can be avoided. The fusion model with adjusted vertexes presents the target expression. Then, the skin map, hair map, illumination environment map, eye map, accessory map and clothing map are fused into the fusion model with adjusted vertexes to obtain the target model.

Optionally, fusing the auxiliary information into the fusion model to obtain a target model may also include: adjusting coordinates of vertexes of the target mesh associated with the target expression in the fusion model according to the vertex displacements to obtain the target model. In embodiments of the present disclosure, vertex coordinates of a target mesh are adjusted through vertex displacements to obtain a target model having rich facial expressions.

Optionally, fusing the auxiliary information into the fusion model to obtain a target model may also include: fusing the illumination environment map into the fusion model to obtain the target model. In embodiments of the present disclosure, an illumination environment map is fused into the fusion model to obtain a target model with rich lighting effects.

Optionally, fusing the auxiliary information into the fusion model to obtain a target model may also include: fusing a texture map into the fusion model to obtain the target model. In embodiments of the present disclosure, fusing the texture map into the fusion model may result in a target model having different appearance.

In technical solutions of embodiments of the present disclosure, a fusion model is obtained by fusing model data of candidate models and then at least one option selected from the group of expression control information, illumination control information and texture control information is fused into the fusion model to obtain a target model. Since the fusion model is a three-dimensional model of a target object, generating the three-dimensional model by fusing model data of candidate models may solve the problem of inefficiency of model creation caused by creating the model using data of the target object in a real scenario. Since expression effects of the fusion model can be controlled through expression control information and the lighting effects of the fusion model can be controlled through illumination control information, a target model more satisfying expectations about expression and lighting effects can be generated.

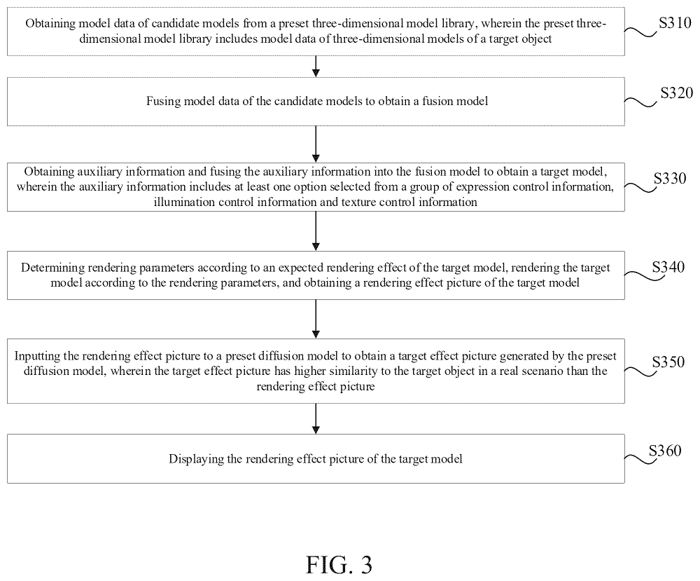

FIG. 3 is another schematic flowchart of the method for data synthesizing in an embodiment of the present disclosure. In the embodiment of the present disclosure, a model rendering step is additionally defined on the basis of the embodiments described above. As shown in FIG. 3, the method includes the following steps.

In S310, model data of candidate models are obtained from a preset three-dimensional model library. The preset three-dimensional model library contains model data of three-dimensional models of a target object.

In S320, model data of the candidate models are fused to obtain a fusion model.

In S330, auxiliary information is obtained and the auxiliary information is fused into the fusion model to obtain a target model, wherein the auxiliary information including at least one option selected from the group of expression control information, illumination control information and texture control information.

In S340, rendering parameters are determined according to expected rendering effects of the target model, and the target model is rendered according to the rendering parameters to obtain a rendering effect picture of the target model.

Here, the rendering effects may represent orientation of the target model in a scenario. Since different scenarios require different orientations of the target model and it is generally not necessary to render all orientations of the target model, camera parameters can be determined according to the orientation required by a scenario. The rendering parameters include camera parameters. For example, the rendering parameters include a camera position. After determination of rendering parameters, a rending scenario is constructed on the basis of the rendering parameters and the target model is rendered on the basis of the rendering scenario to obtain a rendering effect picture of the target model.

In S350, the rendering effect picture is input to a preset diffusion model to obtain a target effect picture generated by the preset diffusion model, wherein the target effect picture has higher similarity to the target object in a real scenario than the rendering effect picture.

Here, the preset diffusion model is obtained through training on the basis of pictures of the target object in real scenarios.

Illustratively, a rendering effect picture is input to the preset diffusion model and image generation is performed by the preset diffusion model on the basis of the rendering effect picture to obtain a target effect picture. Since the preset diffusion model is trained on the basis of three-dimensional models of human faces in real scenarios and as a result models have learned features of human faces in real scenarios, the target effect picture generated on the basis of the preset diffusion model has higher similarity to a real human face than the rendering effect picture. The target effect picture may be used for scenarios such as model training, data enhancement, privacy protection, exploration of new domains, cost reduction, tests and the like. With respect to scenarios for model training, since target effect pictures with rich expressions and rich light and shadow effects can be generated, the target effect pictures may be used to train models, so that performance and accuracy of training may be improved.

In S360, the rendering effect picture of the target model is displayed.

Illustratively, the rendering effect picture of the target model is displayed on a display screen.

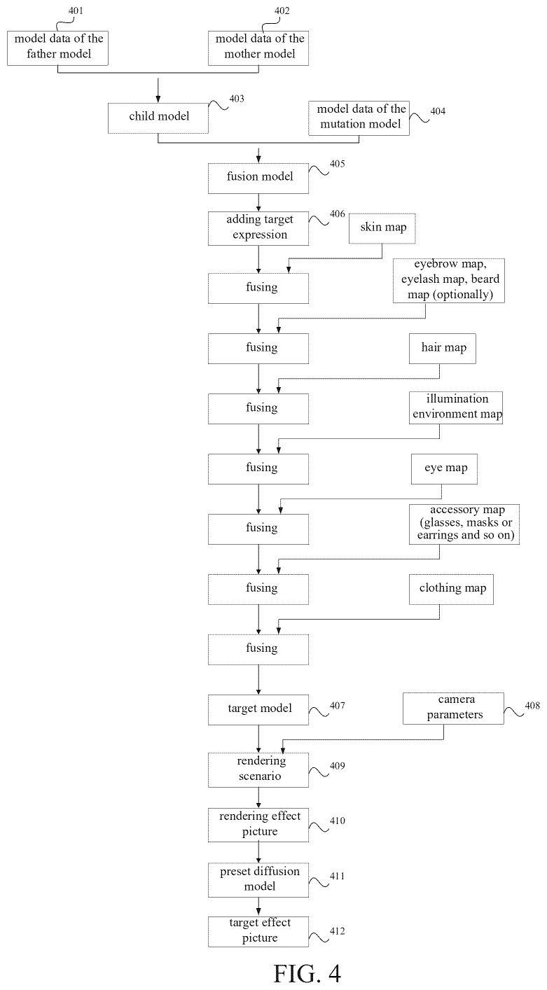

FIG. 4 is yet another schematic flowchart of the method for data synthesizing in an embodiment of the present disclosure. As shown in FIG. 4, the method includes: fusing model data of a father model 401 and model data of a mother model 402 to obtain a child model 403. Model data of a mutation model 404 is fused into the child model 403 to obtain a fusion model 405. Expression control information is fused into the fusion model 405 to add (406) a target expression to the fusion model 405. By image mapping, a skin map, an eyebrow map, an eyelash map, a hair map, an illumination environment map, an eye map, an accessory map and a clothing map are fused into the fusion model, to which an expression has been added. For a male, a beard map needs to be fused into the fusion model, to which an expression has been added, to obtain a target model 407. Camera parameters 408 are determined according to an expected orientation of the target model 407. A rendering scenario 409 is constructed on the basis of the target model 407 and the camera parameters 408. The target model 407 is rendered on the basis of the rendering scenario 409 to obtain a rendering effect picture 410. The rendering effect picture 410 is input to a preset diffusion model 411 to obtain a target effect picture 412 output by the preset diffusion model 411.

In technical solutions of embodiments of the present disclosure, rendering parameters are determined according to expected effects of the target model obtained by fusing model data of candidate models and a rendering scenario is constructed on the basis of the rendering parameters and the target model for rendering to be performed. Since a rendering operation will be performed with the rendering parameters determined using expected effects, the amount of the effects to be rendered is reduced and computing resources are prevented from being wasted. Additionally, after generation of the rendering effect picture, a target effect picture closer to the target object in a real scenario can be generated through a preset diffusion model, so that controllability of the rendering effect picture can be achieved and the degree of resemblance of the image to its real object can be improved.

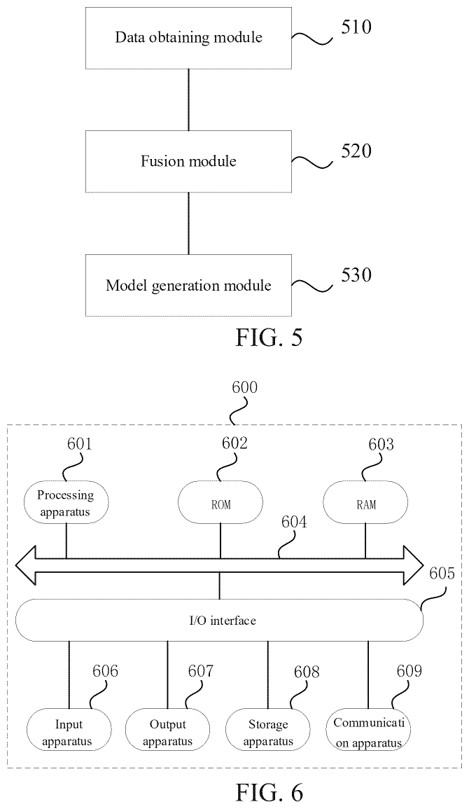

FIG. 5 is a structural diagram of an apparatus for data synthesizing in an embodiment of the present disclosure. The apparatus may be implemented in software and/or hardware and optionally by an electronic device. The electronic device may be a mobile terminal, a PC terminal, a server or the like.

As shown in FIG. 5, the apparatus includes: a data obtaining module 510, a fusion module 520 and a model generation module 530.

The data obtaining module 510 is used to acquire model data of candidate models from a preset three-dimensional model library that includes model data of three-dimensional models of a target object;

the fusion module 520 is used to obtain a fusion model by fusing model data of candidate models; and

the model generation module 530 is used to obtain auxiliary information and fuse the auxiliary information into the fusion model to obtain a target model, wherein the auxiliary information includes at least one of: expression control information, illumination control information and texture control information.

Optionally, the data obtaining module 510 is specifically used to:
display the three-dimensional models in the preset three-dimensional model library;
obtain a configuration operation on the three-dimensional models and determine candidate models and role properties on the basis of the configuration operation, wherein the role property specifies a candidate model as a father model, a mother model or a mutation model; and
obtain model data corresponding to the father model, the mother model and the mutation model respectively from the preset three-dimensional model library.

Optionally, the fusion module 520 is specifically used to:
obtain fusion weights for the candidate models according to the role properties of the candidate models;
fuse the model data corresponding to the father model and the model data corresponding to the mother model to obtain a child model on the basis of the fusion weight corresponding the father model and the fusion weight corresponding the mother model; and
fuse the model data corresponding to the mutation model into the child model on the basis of the fusion weight of the mutation model to obtain the fusion model.

Optionally, the model generation module 530 includes:
an acquisition sub-module that is used to acquire a vertex displacement in a target mesh associated with a target expression in the fusion model, and to
acquire an illumination environment map and a texture map from a preset material library.

Optionally, the model generation module 530 further includes:
a fusion sub-module that is used to adjust vertex coordinates of the target mesh associated with the target expression in the fusion model according to the vertex displacement and fuse the illumination environment map and the texture map into the fusion model with adjusted vertexes to obtain the target model.

Optionally, the apparatus further includes:
a model rendering module that is used to determine, after fusing the auxiliary information into the fusion model and obtaining the target model, rendering parameters according to expected rendering effects of the target model, render the target model according to the rendering parameters and display a rendering effect picture.

Optionally, the apparatus further includes:
a generation module which is configured to input the rendering effect picture to a preset diffusion model and obtain a target effect picture generated by the preset diffusion model before the display of the rendering effect picture of the target model. The target effect picture has higher similarity to the target object in a real scenario than the rendering effect picture,
wherein the preset diffusion model is obtained through training on the basis of pictures of the target object in real scenarios.

The apparatus for data synthesizing provided in the embodiments of the present disclosure can perform the method for data synthesizing in any embodiment of the present disclosure and have the corresponding functional modules, and thus, similar beneficial effects can be achieved.

It to be noted that the units and modules included in the apparatus above are only defined according to their logical functions and the functional division is not limiting as long as the corresponding functions can be realized. Moreover, the specific names of individual functional units are only for the purpose of distinguishing them from each other rather than limiting the scope claimed by embodiments of the present disclosure.

FIG. 6 is a structural diagram of an electronic device in an embodiment of the present disclosure. Referring to FIG. 6 in the following description, a structural diagram of an electronic device 600 (e.g., a terminal device or a server) suitable for implementing embodiments of the present disclosure is shown. The terminal device in the embodiments of the present disclosure may include, but not limited to, mobile terminals such as a mobile phone, a laptop computer, a digital broadcast receiver, a PDA (Personal Digital Assistant), a PAD (a tablet computer), a PMP (Portable Multimedia Player) and a vehicle-mounted terminal (e.g., a vehicle-mounted navigation terminal) as well as fixed terminals such as a digital TV and a desktop computer. The electronic device shown in FIG. 6 is only an example and not intended to limit the functionality and usage scope of embodiments of the present disclosure in any way.

As shown in FIG. 6, the electronic device 600 may include a processing apparatus (e.g., a central processor, a graphics processor or the like) 601 and may perform various appropriate actions and processing operations according to a program stored in a read-only memory (ROM) 602 or a program loaded into a random-access memory (RAM) 603 from a storage apparatus 608. In the RAM 603, various programs and data are stored for operations of the electronic device 600. The processing apparatus 601, the ROM 602 and the RAM 603 may be connected with each other through a bus 604. An input/output (I/O) interface 605 is also connected to the bus 604.

Generally, the following apparatuses may be connected to the I/O interface 605: an input apparatus 606 including, for example, a touch screen, a touch pad, a keyboard, a mouse, a camera, a microphone, an accelerometer, a gyroscope and the like; an output apparatus 607 including, for example, a liquid crystal display (LCD), a loudspeaker, a vibrator and the like; a storage apparatus 608 including, for example, a disk, a hard disk and the like; and a communication apparatus 609. The communication apparatus 609 may allow the electronic device 600 to perform wireless or wired communication with other devices to exchange data. Although FIG. 6 shows the electronic device 600 having various apparatuses, it should be understood that it is not required to implement or have all of the shown apparatuses. Alternatively, the electronic device may have or be implemented by more or fewer apparatuses.

In particular, according to an embodiment of the present disclosure, the process described above with reference to the flowchart may be implemented as a computer software program. For example, this embodiment of the present disclosure includes a computer program product including a computer program carried on a computer-readable medium with the computer program including program code for performing the method shown in the flowchart. In such an embodiment, the computer program may be downloaded and installed from a network through the communication apparatus 609, installed from the storage apparatus 608, or installed from the ROM 602. When the computer program is executed by the processing apparatus 601, the above-mentioned functions defined in the method embodiments of the present disclosure can be performed.

The names of messages or information communicated between a plurality of apparatuses in implementations of the present disclosure are used only for the purpose of illustration rather than limiting the scope of the messages or information.

The electronic device in the embodiments of the present disclosure belongs to the same inventive concept as the method for data synthesizing in the above-described embodiments, the technical details not described in detail in the present embodiment may be seen in the above-described embodiment and the present embodiment may have the same beneficial effects as the above-described embodiment.

An embodiment of the present disclosure provides a computer storage medium storing a computer program that, when executed by a processor, implements the method for data synthesizing in the above-described embodiment.

It should be noted that the computer-readable medium described above in the present disclosure may be a computer-readable signal medium, a computer-readable storage medium, or any combination thereof. The computer-readable storage medium may be, for example but not limited to, any electric, magnetic, optical, electromagnetic, infrared, or semiconductor system, apparatus, or device, or any combination thereof. More specific examples of the computer-readable storage medium may include, but are not limited to, an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, clients and servers may communicate through any network protocol known at present or developed in the future such as the HyperText Transfer Protocol (HTTP) or the like, and may be interconnected with any digital data communication (e.g., a communication network) in any form or through any medium. Examples of the communication network include a local area network (LAN), a wide area network (WAN), an internet network (e.g., the Internet) and a peer-to-peer (P2P) network (e.g., an ad hoc P2P network) as well as any network known at present or developed in the future.

The above-mentioned computer-readable medium may be contained by the above-described electronic device, or may exist independently without being assembled into the electronic device.

The above-mentioned computer-readable medium may carry one or more programs that, when executed by the electronic device, cause the electronic device:
obtain model data of candidate models from a preset three-dimensional model library that contains model data of three-dimensional models of a target object;
fuse model data of the candidate models to obtain a fusion model; and
obtain auxiliary information and fuse the auxiliary information into the fusion model to obtain a target model, wherein the auxiliary information includes at least one of expression control information, illumination control information and texture control information.

The computer program code for performing the operations in the present disclosure may be written in one or more programming languages or a combination thereof, where the programming languages include, but not limited to, an object-oriented programming language such as Java, Smalltalk, or C++, and also include conventional procedural programming languages, such as “C” languages or similar programming languages. The program code may be completely executed on a computer of a user, partially executed on a computer of a user, executed as an independent software package, partially executed on a computer of a user and partially executed on a remote computer, or completely executed on a remote computer or server. In a scenario with a remote computer involved, the remote computer may be connected to a computer of a user via any kind of network, including a local area network (LAN) or a wide area network (WAN), or may be connected to an external computer (for example, via the Internet with the aid of an Internet service provider).

The flowcharts and block diagrams in the accompanying drawings illustrate the possible implementation architecture, functions, and operations of the system, method, and computer program product according to various embodiments of the present disclosure. In this regard, each box in a flowchart or block diagram can represent a module, program segment, or part of code that contains one or more executable instructions for implementing specified logical functions. It should also be noted that in some alternative implementations, the functions marked in the boxes may occur in a different order than those marked in the drawings. For example, two consecutive boxes can actually be executed in parallel, and sometimes they can also be executed in reverse order, depending on the functions involved. It should also be noted that each box in the block diagram and/or flowchart, as well as combinations of boxes in the block diagram and/or flowchart, can be implemented using dedicated hardware-based systems that perform specified functions or operations, or can be implemented using a combination of dedicated hardware and computer instructions.

The units described in the embodiments of the present disclosure can be implemented through software or hardware. In some cases, the name of a unit does not constitute a limitation on the unit itself. For example, a first acquisition unit can also be described as a unit for obtaining at least two Internet Protocol addresses.

The functions described above herein can be at least partially executed by one or more hardware logic components. For example, non-limiting exemplary types of hardware logic components that can be used include: Field Programmable Gate Arrays (FPGAs), Application Specific Integrated Circuits (ASICs), Application Specific Standard Products (ASSPs), System on Chip (SOC), Complex Programmable Logic Devices (CPLDs), and so on.

In the context of the present disclosure, a machine-readable medium may be a tangible medium that contains or stores programs for use by or in combination with an instruction execution system, apparatus, or device. Machine readable media can be machine readable signal media or machine-readable storage media. Machine-readable media may include, but are not limited to, electronic, magnetic, optical, electromagnetic, infrared, or semiconductor systems, devices, or equipment, or any suitable combination of the above. More specific examples of machine-readable storage media include electrical connections based on one or more wires, portable computer disks, hard drives, random access memory (RAM), read-only memory (ROM), erasable programmable read-only memory (EPROM or flash memory), optical fibers, compact disc read-only memory (CD-ROM), optical storage devices, magnetic storage devices, or any suitable combination of the above.

The above description only relates to preferred embodiments of the present disclosure and explanations of the technical principles applied. Technicians in the field should understand that the scope referred to in the present disclosure is not limited to technical solutions formed by specific combinations of the above technical features, and should also cover other technical solutions formed by arbitrary combinations of the above technical features or their equivalent features without departing from the above disclosed concept. For example, a technical solution formed by replacing the above features with (but not limited to) technical features with similar functions disclosed herein.

In addition, although the operations are depicted in a specific order, this should not be understood as requiring these operations to be executed in the specific order shown or in a sequential order. Under certain circumstances, multitasking and parallel processing may be advantageous. Similarly, although several specific implementation details are included in the above discussion, they should not be interpreted as limiting the scope of the present disclosure. Certain features described in the context of individual embodiments can also be combined and implemented in a single embodiment. On the contrary, various features described in the context of a single embodiment can also be implemented individually or in any suitable sub combination in multiple embodiments.

Although the subject matter has been described using language specific to structural features and/or method logic actions, it should be understood that the subject matter defined in the appended claims is not necessarily limited to the specific features or actions described above. On the contrary, the specific features and actions described above are merely exemplary forms of implementing the claims.

1. A method for data synthesizing, comprising:
obtaining model data of candidate models from a preset three-dimensional model library, wherein the preset three-dimensional model library comprises model data of three-dimensional models of a target object;
fusing model data of the candidate models to obtain a fusion model; and
obtaining auxiliary information and fusing the auxiliary information into the fusion model to obtain a target model, wherein the auxiliary information comprises at least one option selected from a group of expression control information, illumination control information and texture control information.

2. The method of claim 1, wherein obtaining model data of candidate models from a preset three-dimensional model library comprises:
displaying the three-dimensional models in the preset three-dimensional model library;
obtaining a configuration operation on the three-dimensional models and determining the candidate models and role properties based on the configuration operation, wherein the role property specifies a candidate model as a father model, a mother model or a mutation model; and
obtaining model data corresponding to the father model, the mother model and the mutation model respectively from the preset three-dimensional model library.

3. The method of claim 2, wherein fusing model data of the candidate models to obtain a fusion model comprises:
obtaining fusion weights for the candidate models according to the role properties of the candidate models;
fusing the model data corresponding to the father model and the model data corresponding to the mother model to obtain a child model based on a fusion weight corresponding the father model and a fusion weight corresponding the mother model; and
fusing the model data corresponding to the mutation model into the child model based on the fusion weight of the mutation model to obtain the fusion model.

4. The method of claim 1, wherein obtaining auxiliary information comprises:
acquiring a vertex displacement of a target mesh associated with a target expression and the fusion model; and
acquiring an illumination environment map and a texture map from a preset material library.

5. The method of claim 4, wherein fusing the auxiliary information into the fusion model to obtain a target model comprises:
adjusting coordinates of vertexes of the target mesh associated with the target expression in the fusion model according to the vertex displacement; and
fusing the illumination environment map and the texture map into the fusion model with adjusted vertexes to obtain the target model.

6. The method of claim 1, wherein after fusing the auxiliary information into the fusion model to obtain a target model, the method further comprises:
determining rendering parameters according to an expected rendering effect of the target model, rendering the target model according to the rendering parameters, and displaying a rendering effect picture of the target model.

7. The method of claim 6, wherein before displaying a rendering effect picture of the target model, the method further comprises:
inputting the rendering effect picture to a preset diffusion model to obtain a target effect picture generated by the preset diffusion model, wherein the target effect picture has higher similarity to the target object in a real scenario than the rendering effect picture, and
wherein the preset diffusion model is obtained through training on the basis of pictures of the target object in real scenarios.

8. An apparatus for data synthesizing, comprising:
a processor; and
a non-transitory memory with instructions thereon,
wherein the instructions, upon execution by the processor, cause the processor to:
obtain model data of candidate models from a preset three-dimensional model library, wherein the preset three-dimensional model library comprises model data of three-dimensional models of a target object;
fuse model data of the candidate models to obtain a fusion model; and
obtain auxiliary information and fuse the auxiliary information into the fusion model to obtain a target model, wherein the auxiliary information comprises at least one option selected from a group of expression control information, illumination control information and texture control information.

9. The apparatus of claim 8, wherein obtaining model data of candidate models from a preset three-dimensional model library by the processor comprises:
displaying the three-dimensional models in the preset three-dimensional model library;
obtaining a configuration operation on the three-dimensional models and determining the candidate models and role properties based on the configuration operation, wherein the role property specifies a candidate model as a father model, a mother model or a mutation model; and
obtaining model data corresponding to the father model, the mother model and the mutation model respectively from the preset three-dimensional model library.

10. The apparatus of claim 9, wherein fusing model data of the candidate models to obtain a fusion model by the processor comprises:
obtaining fusion weights for the candidate models according to the role properties of the candidate models;
fusing the model data corresponding to the father model and the model data corresponding to the mother model to obtain a child model based on a fusion weight corresponding the father model and a fusion weight corresponding the mother model; and
fusing the model data corresponding to the mutation model into the child model based on the fusion weight of the mutation model to obtain the fusion model.

11. The apparatus of claim 8, wherein obtaining auxiliary information by the processor comprises:
acquiring a vertex displacement of a target mesh associated with a target expression and the fusion model; and
acquiring an illumination environment map and a texture map from a preset material library.

12. The apparatus of claim 11, wherein fusing the auxiliary information into the fusion model to obtain a target model by the processor comprises:
adjusting coordinates of vertexes of the target mesh associated with the target expression in the fusion model according to the vertex displacement; and
fusing the illumination environment map and the texture map into the fusion model with adjusted vertexes to obtain the target model.

13. The apparatus of claim 8, wherein after fusing the auxiliary information into the fusion model to obtain a target model, the processor is further caused to:
determine rendering parameters according to an expected rendering effect of the target model, render the target model according to the rendering parameters, and display a rendering effect picture of the target model.

14. The apparatus of claim 13, wherein before displaying a rendering effect picture of the target model, the processor is further caused to:
input the rendering effect picture to a preset diffusion model to obtain a target effect picture generated by the preset diffusion model, wherein the target effect picture has higher similarity to the target object in a real scenario than the rendering effect picture, and
wherein the preset diffusion model is obtained through training on the basis of pictures of the target object in real scenarios.

15. A non-transitory computer-readable storage medium storing instructions that cause a processor to:
obtain model data of candidate models from a preset three-dimensional model library, wherein the preset three-dimensional model library comprises model data of three-dimensional models of a target object;
fuse model data of the candidate models to obtain a fusion model; and
obtain auxiliary information and fuse the auxiliary information into the fusion model to obtain a target model, wherein the auxiliary information comprises at least one option selected from a group of expression control information, illumination control information and texture control information.

16. The non-transitory computer-readable storage medium of claim 15, wherein obtaining model data of candidate models from a preset three-dimensional model library by the processor comprises:
displaying the three-dimensional models in the preset three-dimensional model library;
obtaining a configuration operation on the three-dimensional models and determining the candidate models and role properties based on the configuration operation, wherein the role property specifies a candidate model as a father model, a mother model or a mutation model; and
obtaining model data corresponding to the father model, the mother model and the mutation model respectively from the preset three-dimensional model library.

17. The non-transitory computer-readable storage medium of claim 16, wherein fusing model data of the candidate models to obtain a fusion model by the processor comprises:
obtaining fusion weights for the candidate models according to the role properties of the candidate models;
fusing the model data corresponding to the father model and the model data corresponding to the mother model to obtain a child model based on a fusion weight corresponding the father model and a fusion weight corresponding the mother model; and
fusing the model data corresponding to the mutation model into the child model based on the fusion weight of the mutation model to obtain the fusion model.

18. The non-transitory computer-readable storage medium of claim 15, wherein obtaining auxiliary information by the processor comprises:
acquiring a vertex displacement of a target mesh associated with a target expression and the fusion model; and
acquiring an illumination environment map and a texture map from a preset material library.

19. The non-transitory computer-readable storage medium of claim 18, wherein fusing the auxiliary information into the fusion model to obtain a target model by the processor comprises:
adjusting coordinates of vertexes of the target mesh associated with the target expression in the fusion model according to the vertex displacement; and
fusing the illumination environment map and the texture map into the fusion model with adjusted vertexes to obtain the target model.

20. The non-transitory computer-readable storage medium of claim 15, wherein after fusing the auxiliary information into the fusion model to obtain a target model, the processor is further caused to:
determine rendering parameters according to an expected rendering effect of the target model, render the target model according to the rendering parameters, and display a rendering effect picture of the target model.
